(19) United States
(12) Patent Application Publication
(10) Pub. No.: US 2026/0308933 A1
(43) Pub. Date: Oct. 8, 2026

(54) COVER SYSTEM FOR LIGHT POLE FOOTINGS

(71) Applicant: Jason Schumacher, Tea, SD (US)

(72) Inventor: Jason Schumacher, Tea, SD (US)

(21) Appl. No.: 19/171,617

(22) Filed: Apr. 7, 2025

(51) Int. Cl. E04H 12/22; F21S 8/08

(52) U.S. Cl. CPC E04H 12/2261; F21S 8/085

(57) ABSTRACT

A light pole footing cover system includes a shell defining a cavity having an opening at a bottom end of the shell. A handle is coupled to the shell. A base channel is coupled to and extends around the bottom end of the shell. The base channel is weighted for placement of the shell in a static position covering a light pole footing such that the shell obscures access to the light pole footing.

### (b) CROSS-REFERENCE TO RELATED APPLICATIONS

Not applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cover systems and more particularly pertains to a new cover system for covering exposed wiring from downed light poles.

### (2) Description of Related Art including Information Disclosed Under 37 CFR 1.97 and 1.98

When light poles for streetlights are removed from their footings, either via intentional dismantling or destruction from vehicle collisions or the like, the wiring which electrically attached to the streetlights becomes exposed to the environment and can post a hazard to passersby. The prior art discloses enclosures which store wiring or various light pole accessories between a light pole and a footing to which the light pole is to be mounted. The enclosures often act to mount the light pole to the footing in addition to storing wiring and accessories. Known prior art lacks efficient storage and transport of a cover apparatus which may be quickly and simply deployed over a light pole footing.

### (h) BRIEF SUMMARY OF THE INVENTION

An embodiment of the disclosure meets the needs presented above by generally comprising a shell defining a cavity having an opening at a bottom end of the shell. A handle is coupled to the shell. A base channel is coupled to and extends around the bottom end of the shell. The base channel is weighted for placement of the shell in a static position covering a light pole footing such that the shell obscures access to the light pole footing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a light pole footing cover system according to an embodiment of the disclosure.

FIG. 2 is a cut away side view of an embodiment of the disclosure.

FIG. 3 is a detailed view of an embodiment of the disclosure.

FIG. 4 is a cross-sectional view of an embodiment of the disclosure taken along line 4-4 of FIG. 2.

FIG. 5 is a cross-sectional view of an embodiment of the disclosure taken along line 5-5 of FIG. 2.

### (J) DETAILED DESCRIPTION OF THE INVENTION

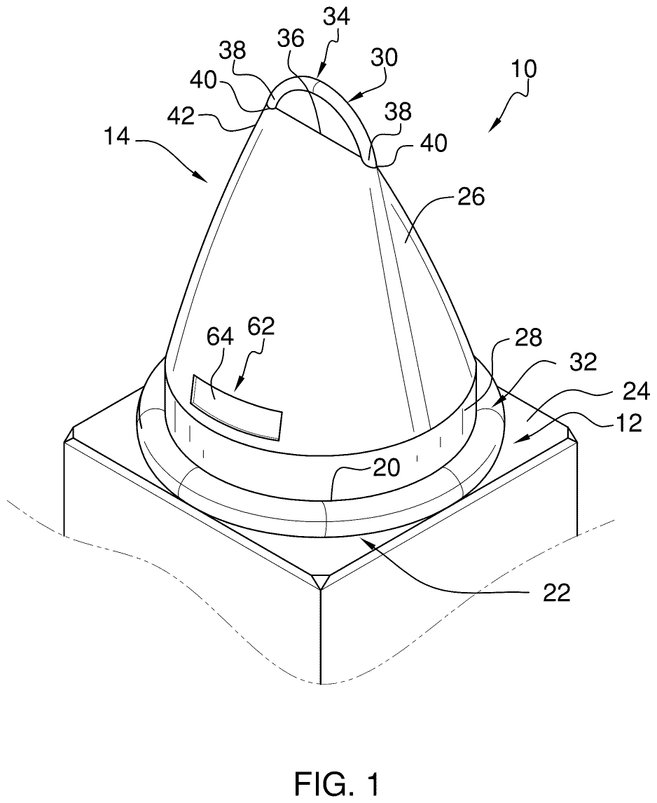

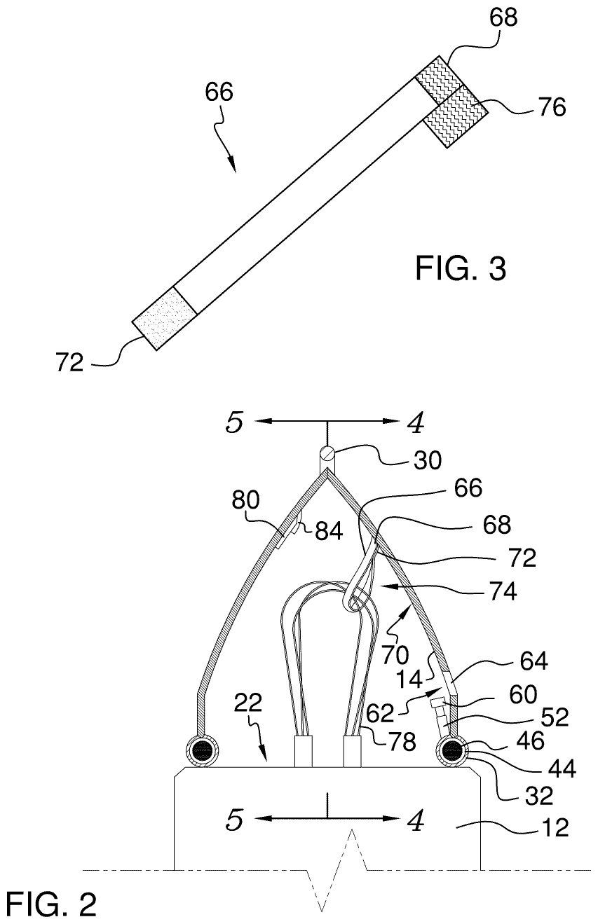

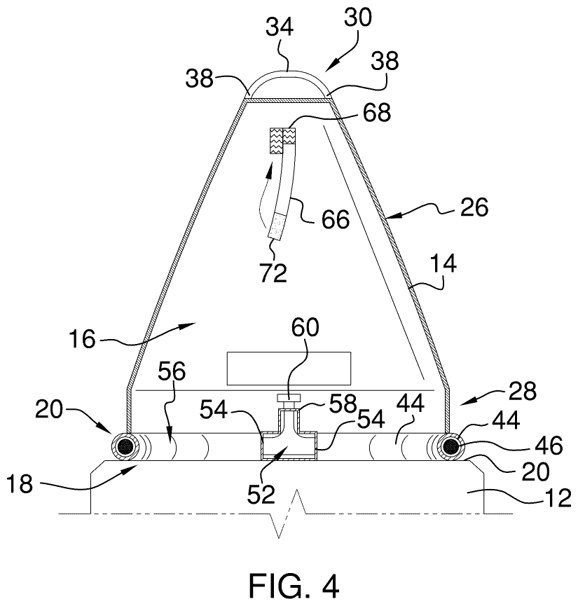

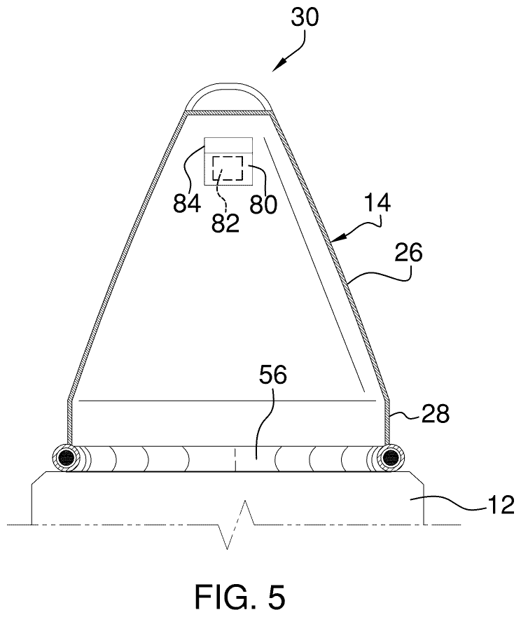

With reference now to the drawings, and in particular to FIGS. 1 through 5 thereof, a new cover system embodying the principles and concepts of an embodiment of the disclosure and generally designated by the reference numeral 10 will be described.

As best illustrated in FIGS. 1 through 5, the light pole footing cover system 10 generally comprises a light pole footing 12 and a shell 14 defining a cavity 16 with an opening 18 at a bottom end 20 of the shell 14. The shell 14 may be constructed of vinyl coated polyvinyl chloride fabric. The opening 18 is sized to cover a central section 22 of an upper surface 24 of the light pole footing 12. The shell 14 has an upper section 26 and a lower section 28. The upper section 26 is conical and the lower section 28 is cylindrical such that multiple shells 14 may be nested to reduce space required to transport multiple shells 14. A handle 30 is coupled to the shell 14. A base channel 32 is coupled to and extends around the bottom end 20 of the shell 14. The base channel 32 may be attached conventionally or be an integral extension of the lower section 28. The base channel 32 is weighted for being placed in a static position covering the light pole footing 12 such that the shell 14 obscures access to the light pole footing 12.

The lower section 28 of the shell 14 may have having a height between 4 inches and 12 inches, more particularly being 6 inches for use with a conventional or standard size light pole footing 12. The upper section 26 of the shell 14 may have a height extending from the lower section 28 which is between 16 inches and 28 inches.

The handle 30 has a grip 34 positioned in spaced relationship to an upper edge 36 of the shell 14. The handle 30 has a pair of outer sections 38. The grip 34 is coupled to and positioned between the outer sections 38. The outer sections 38 are coupled to the shell 14 and angled relative to the grip 34 such that the outer sections 38 extend outwardly and downwardly from the grip 34. An outer edge 40 of each of the outer sections 38 of the handle 30 is linearly aligned with an outer surface 42 of the upper section 26 of the shell 14. The handle 30 may have a width between 6 inches and 10 inches between outermost points of the outer sections 38.

A tube 44 is positioned in the base channel 32. The tube 44 is annular extending around a full circumference of the bottom end 20 of the shell 14. The tube 44 has a cross-sectional diameter between 1 inch and 3 inches, more particularly being 2 inches. A weighting material 46 is positioned within the tube 44. The weighting material 46 may be sand, pebbles, or the like.

The lower section 28 of the shell 14 has a diameter such that the bottom end 20 of the shell 14 is sized for positioning on a support surface extending laterally from an outer peripheral edge of the light pole footing 12. This may be a diameter of between 20 inches and 36 inches. Alternatively and as shown, the lower section 28 of the shell 14 may have a diameter such that the bottom end 20 of the shell 14 is positionable to rest on the upper surface 24 of the light pole footing 12.

A tee 52 has linearly aligned openings 54 coupled to respective ends of the tube 44 such that the tube 44 defines a ring 56 extending through the base channel 32. The tee 52 includes an upwardly facing opening 58 extending upwardly out of the base channel 32 for putting the weighting material 46 into the tube 44. A cap 60 is removably couplable to the tee 52 for selectively closing the upwardly facing opening 58 of the tee 52. The cap 60 is removable for removing the weighting material 46 from the tube 44. A fill opening 62 extends through the shell 14. The fill opening 62 is positioned vertically aligned with the upwardly facing opening 58 of the tee 52 to provide access to filling the tube 44 through the fill opening 62. The shell 14 includes a fill flap 64 positionable for selectively covering the fill opening 62. The fill flap 64 may be secured in the closing position by a fastener such as hook and loop fastener or the like.

A strap 66 has a first end 68 coupled to an interior surface 70 of the shell 14. The strap 66 has a second end 72 removably couplable to form a loop 74. The second end 72 may be coupled directly to the interior surface 70, to the strap 66, or to a tab 76 extending from the strap 66 adjacent the first end 68. Thus, the strap 66 is configured for looping around exposed wires 78 extending from the light pole footing 12 such that the strap 66 holds the exposed wires 78 in a position extending upwardly from the light pole footing 12. This inhibits the exposed wires from undesired contact with the ground, water, or with any other surface which may create an undesired result. The strap 66 can be secured into the loop 74 using a fastener such as hook and loop fastener or the like.

A pocket 80 is positioned on the interior surface 70 of the shell 14. A global positioning device 82 is removably positionable in the pocket 80 for facilitating tracking of a position of the shell 14, facilitating recovery in the event of theft or for facilitating location of a damaged light pole footing covered by the shell 14. A pocket flap 84 is coupled to the interior surface 70 of the shell 14 and is securable to close the pocket 80 for preventing the global positioning device 82 from being removed from the pocket 80 inadvertently. The pocket flap 84 may be secured using hook and loop fastener or the like.

In use, the shell 14 is transported to the light pole footing 12, which is typically one under construction, or damaged and needing repair. The shell 14 is positioned to cover the light pole footing 12 restricting access to the light pole footing 12 and any exposed wiring which may be present. Additionally, a lock or other device may be used to further secure the shell 14 in place to prevent undesired removal of the shell 14 from covering the light pole footing 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light pole footing cover system comprising:
a shell defining a cavity therein with an opening at a bottom end of the shell, said opening having a size such that the opening is configured to receive the light pole footing;
a handle coupled to said shell; and
a base channel coupled to and extending around said bottom end of said shell, the base channel being weighted wherein said shell is configured for being placed in a static position covering a light pole footing such that said shell obscures access to the light pole footing.

2. The light pole footing cover system of claim 1, further comprising said shell having an upper section and a lower section, said upper section being conical, said lower section being cylindrical.

3. The light pole footing cover system of claim 1, further comprising said handle having a grip positioned in spaced relationship to an upper edge of said shell.

4. The light pole footing cover system of claim 4, further comprising said handle having a pair of outer sections, said grip being coupled to and positioned between said outer sections, said outer sections being coupled to said shell.

5. The light pole footing cover system of claim 4, further comprising said outer sections being angled relative to said grip such that said outer sections extend outwardly and downwardly from said grip.

6. The light pole footing cover system of claim 4, further comprising:
said shell having an upper section, said upper section being conical; and
an outer edge of each of said outer sections of said handle being linearly aligned with an outer surface of said upper section of said shell.

7. The light pole footing cover system of claim 1, further comprising:
a tube positioned in said base channel; and
a weighting material being positioned within said tube.

8. The light pole footing cover system of claim 7, further comprising said tube being annular extending around a full circumference of said bottom end of said shell.

9. The light pole footing cover system of claim 7, further comprising said tube having a cross-sectional diameter between 1 inch and 3 inches.

10. The light pole footing cover system of claim 7, comprising a tee having linearly aligned openings coupled to respective ends of said tube such that said tube defines a ring.

11. The light pole footing cover system of claim 10, further comprising:
said tee including an upwardly facing opening extending upwardly out of said base channel wherein said tee is configured for putting said weighting material into said tube; and
a cap couplable to said tee for selectively closing said upwardly facing opening of said tee.

12. The light pole footing cover system of claim 11, further comprising a fill opening extending through said shell, said fill opening being positioned vertically aligned with said upwardly facing opening of said tee.

13. The light pole footing cover system of claim 12, further comprising said shell including a fill flap, said fill flap being positionable for selectively covering said fill opening.

14. The light pole footing cover system of claim 1, further comprising a strap having a first end coupled to an interior surface of said shell, said strap having a second end removably couplable to form a loop wherein said strap is configured for looping around wires extending from the light pole footing such that said strap holds said exposed wires in a position extending upwardly from the light pole footing.

15. The light pole footing cover system of claim 1, further comprising:
a pocket positioned on an interior surface of said shell; and
a global positioning device being removably positionable in said pocket for facilitating tracking of a position of the shell.

16. The light pole footing cover system of claim 15, further comprising a pocket flap coupled to said interior surface of said shell and securable to close said pocket wherein said pocket flap is configured for preventing said global positioning device from being removed from said pocket.

17. The light pole footing cover system of claim 1, further comprising said shell being constructed of vinyl coated polyvinyl chloride fabric.
